(19) United States
(12) Patent Application Publication
(10) Pub. No.: US 2007/0210670 A1
(43) Pub. Date: Sep. 13, 2007

(54) Motor

(75) Inventors: Satoshi Ueda, Minami-ku (JP); Tadayuki Kanatani, Minami-ku (JP); Hiroaki Sasaoka, Minami-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 11/714,250

(22) Filed: Mar. 6, 2007

(30) Foreign Application Priority Data
Mar. 7, 2006 (JP) 2006-060585

(51) Int. Cl. H01R 39/38

(52) U.S. Cl. 310/238

(57) ABSTRACT

An axial gap between an annular projection of a rotor hub of a rotary unit and a sliding seal is set to be smaller than an axial gap between an axially upper face of a shaft and a cover of the rotor hub and an axially gap between an axially lower end face of a sleeve and an axially upper face of a radially-extending part of a bush. Thus, only the annular projection and the sliding seal come into contact with each other, even if the rotary unit moves downward in the axial direction.

### BACKGROUND OF THE INVENTION

1. Technical Fields

The present invention relates to a motor and, more particularly, to a motor used at high rotation speed.

2. Background of the Related Art

In order to achieve motors that can rotate at higher speed and have a longer life and a lower noise, motor using an air dynamic pressure for a bearing in place of a ball bearing or hydrodynamic bearing have been developed.

FIG. 13 shows a conventional structure for supporting a rotary unit of a motor in its axial direction. FIG. 13 is a cross-sectional view of the motor, taken along a plane including the axial direction.

Referring to FIG. 13, a rotary unit 1 includes a cylindrical rotor hub 1a opposed to a shaft 2 with a radial gap interposed therebetween, a rotor magnet 1b secured to an outer circumferential surface of the rotor hub 1a, and a cover 1c secured to the top of the rotor hub 1a and opposed to an axially upper top face of the shaft 2 with an axial gap interposed therebetween. The shaft 2 is arranged coaxially with a rotation axis J1 of the motor. The cover 1c includes an axial supporting portion 1c1 arranged coaxially with the rotation axis J1. The axial supporting portion 1c1 has a spherical surface facing the shaft 2. The axial supporting portion 1c1 is in contact with the axially upper face of the shaft 2, thereby axially supporting the shaft 2. The axial supporting portion 1c1 is arranged at a position adjacent to a bearing 3 formed between an outer circumferential surface of the shaft 2 and an inner circumferential surface of the rotor hub 1a.

The axial supporting portion 1c1 and the axially upper face of the shaft 2 are in contact with each other at a point. Therefore, when a sudden force is applied downward in the axial direction by an external shock or the like, the contact pressure applied to the axial supporting portion 1c1 and the axially upper face of the shaft 2 increases. The increase in the contact pressure may cause a breakage of the axial supporting portion 1c1 and a part of the axially upper face of the shaft 2. It is likely that a broken piece enters the bearing 3 adjacent to the axial supporting portion 1c1. As a result, the broken piece comes into contact with the outer circumferential surface of the shaft 2 and the inner circumferential surface of the rotor hub 1a, thus causing seizing of the bearing 3.

### BRIEF SUMMARY OF THE INVENTION

According to preferred embodiments of the present invention, a movement regulating portion that prevents a rotary unit from moving axially downward is provided in the radially outside of a bearing in a fixed unit, thereby preventing a broken piece or the like formed by contact between the rotary unit and the fixed unit in the movement regulating portion from entering the bearing.

The configuration will be described in detail. A motor includes a fixed unit, a rotary unit, and a bearing supporting the rotary unit in a rotatable manner relative to the fixed unit. One of the fixed unit and the rotary unit includes a hollow, approximately cylindrical sleeve, while the other includes a shaft received in the sleeve in a rotatable manner relative to an inner circumferential surface of the sleeve. The bearing has a radial dynamic pressure bearing mechanism generating a radial supporting force by rotating in a predetermined direction between an outer circumferential surface of the shaft and the inner circumferential surface of the sleeve. At least one of the fixed unit and the rotary unit includes an annular first contact portion surrounding a rotation axis. The first contact portion is arranged radially outside the radial dynamic pressure bearing mechanism. The other one of the fixed unit and the rotary unit has a second contact portion axially opposed to the first contact portion. An axial gap between the first and second contact portions is smaller than axial gaps between the fixed unit and the rotary unit other than the first and second contact portions.

### BRIEF DESCRIPTION OF THE SEVERAL VIEWS OF THE DRAWINGS

FIG. 1 is a schematic cross-sectional view of a motor according to a preferred embodiment of the present invention, taken along a plane parallel to its axial direction.

FIG. 2 is an enlarged view of a portion of the motor, surrounded by an ellipse of alternate long and short dash line in FIG. 1.

FIG. 3 is an enlarged view of a movement regulating portion of the motor, surrounded by a circle of dotted line in FIG. 1.

FIG. 4 shows relationships among gaps between a fixed unit and a rotary unit of the motor of FIG. 1.

FIG. 5 is an enlarged view of a portion of the motor around a bearing.

FIG. 6 is a schematic cross-sectional view of a motor according to another preferred embodiment of the present invention, taken along a plane including its axial direction.

FIG. 7 is an enlarged view of a portion of the motor around a bearing.

FIG. 8 is a flowchart of a motor manufacturing method according to a preferred embodiment of the present invention.

FIG. 9 is an assembly diagram, showing Step S1 in FIG. 8.

FIG. 10 is an assembly diagram, showing Step S2 in FIG. 8.

FIG. 11 is an assembly diagram, showing Step S3 in FIG. 8.

FIG. 12 is an assembly diagram, showing Step S4 in FIG. 8.

FIG. 13 is a schematic cross-sectional view of an exemplary conventional motor, taken along a plane including its axial direction.

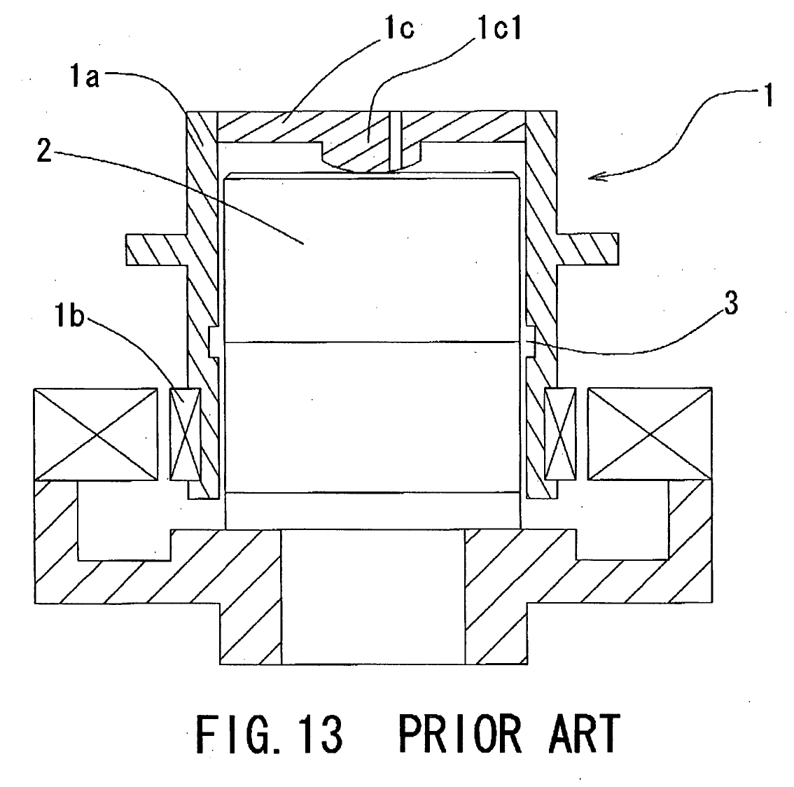

### DETAILED DESCRIPTION OF THE INVENTION

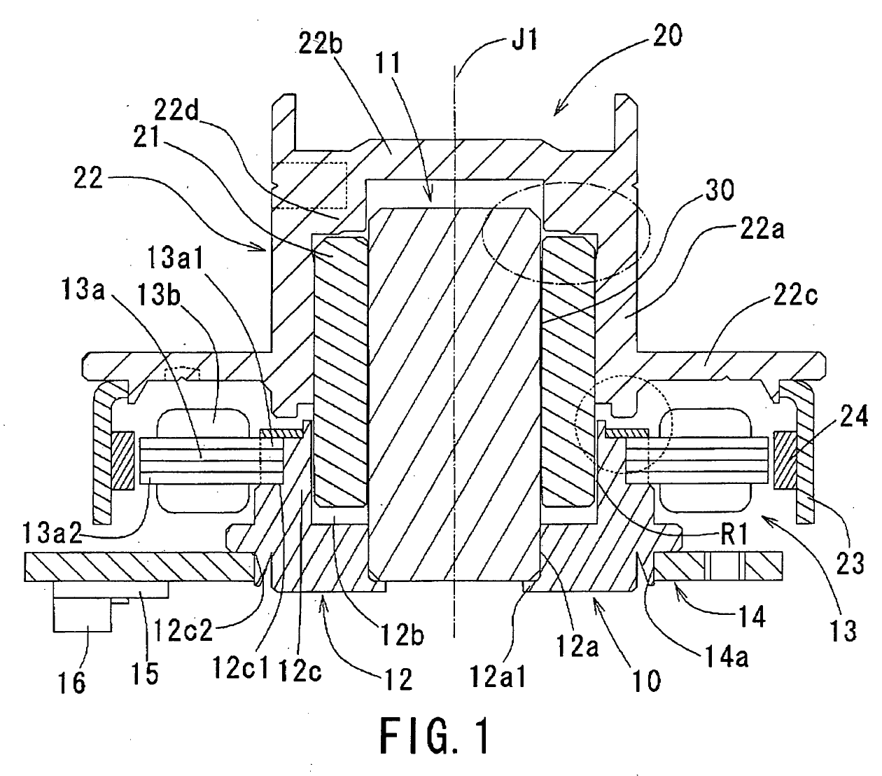

Referring to FIGS. 1 through 12, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

### <General Structure of Motor>

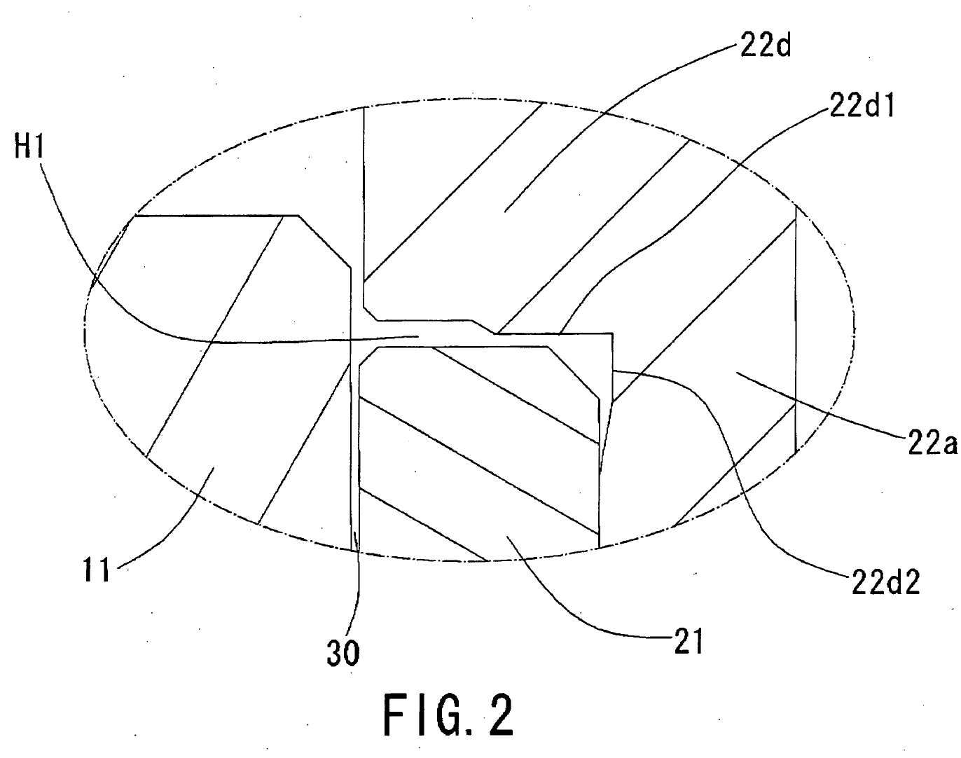

A motor according to a preferred embodiment of the present invention is described, referring to FIGS. 1 and 2. FIG. 1 is a schematic cross-sectional view of the motor, taken along a plane parallel to the axial direction of the motor. FIG. 2 is an enlarged view of a portion of the motor encircled by an ellipse of alternate long and short dash line in FIG. 1.

Referring to FIG. 1, the motor of this preferred embodiment includes a fixed unit 10, a rotary unit 20 rotating relative to the fixed unit 10, and a bearing 30 formed between the fixed unit 10 and the rotary unit 20. The bearing 30 supports the rotary unit 20 in a rotatable manner relative to the fixed unit 10.

### 1) Fixed Unit 10

The fixed unit 10 includes a shaft 11 in the form of a cylindrical column arranged coaxially with a rotation axis J1, a hollow, approximately cylindrical bush 12 secured to an axially lower part of the shaft 11, a stator 13 secured to an axially upper part of an outer circumferential surface of the bush 12, and a mounting plate 14 secured to the outer circumferential surface of the bush 12 axially below the stator 13.

The shaft 11 is fixed along the rotation axis J1 and is formed of ceramic. On an outer circumferential surface of the shaft 11 is formed a radial dynamic pressure-generating groove (not shown) for generating a dynamic pressure and obtaining a radial supporting force.

The bush 12 includes a shaft fixing portion 12a for fixing the axially lower part of the shaft 11. The shaft fixing portion 12a is cylindrical and has a hollow penetrating in the axial direction. An annular projection 12a1 that axially positions the shaft 11 is formed at an axially lower end of the shaft fixing portion 12a. The annular projection 12a1 is arranged radially inside the shaft fixing portion 12a. It is preferable to fix the outer circumferential surface of the shaft 11 and the shaft fixing portion 12a to each other by press-fitting. In order to improve the fixing strength between the shaft 11 and the shaft fixing portion 12a, adhesive may be applied.

A radially-extending portion 12b extending radially outward is formed at an axially upper end of the shaft fixing portion 12a of the bush 12. An outer cylindrical portion 12c extending axially upward is formed continuously from the radially-extending portion 12b. An upper step 12c1 on which the stator 13 is to be mounted is formed in an upper part of an outer circumferential surface of the outer cylindrical portion 12c. A lower step 12c2 for securing the mounting plate 14 thereto is formed in the outer circumferential surface of the bush 12 so as to be continued from the outer cylindrical portion 12c. The lower step 12c2 is below the upper step 12c1.

The stator 13 has a stator core 13a formed by stacking a plurality of (four in this preferred embodiment) thin magnetic steel plates, and a coil 13b formed by winding a wire around the stator core 13a. The stator core 13a includes a core back portion 13a1 having an annular shape on its radially inner side and teeth 13a2 extending radially outward from the core back portion 13a1. The coil 13b is formed by winding a wire around the tooth 13a2. The core back portion 13a1 is positioned in both the axial and radial directions by an axially upper face of the upper step 12c1 of the bush 12 and the outer circumferential surface of the bush 12 continued from the upper step 12c1, respectively. The bush 12 and the stator 13 are fixed to each other by applying adhesive between the outer circumferential surface of the bush 12 and the inner circumferential surface of the core back portion 13a1 of the stator 13.

The mounting plate 14 is formed from a steel plate by plastic work such as pressing. In the mounting plate 14, a hole 14a is formed which engages with the lower step 12c2 of the bush 12. The mounting plate 14 is positioned in the axial and radial directions by coming into contact with the lower step 12c2. The mounting plate 14 and the bush 12 are fixed to each other with an inner rim of the mounting plate 14 sandwiched between a deformed part of an axially lower end face of the bush 12 and another part of the bush 12 by plastic work such as crimping.

A circuit board 15 is secured to an axially lower face of the mounting plate 14 by, for example, bonding. A lead wire of the coil 13b is secured to the circuit board 15 by soldering or the like. A connector 16 connected to an external power supply (not shown) is fixed to an axially lower face of the circuit board 15 by soldering or the like.

### 2) Rotary Unit 20

Referring to FIG. 1, the rotary unit 20 includes a hollow, approximately cylindrical sleeve 21. The sleeve 21 has an inner circumferential surface radially opposed to the outer circumferential surface of the shaft 11 with a small radial gap interposed therebetween. The rotary unit 20 also includes a hollow, approximately cylindrical rotor hub 22 secured to an outer circumferential surface of the sleeve 21, a yoke 23 serving as a rotor magnet holding portion secured to the rotor hub 22, and a rotor magnet 24 secured to an inner circumferential surface of the yoke 23.

The sleeve 21 is formed of ceramic. With the configuration, even if the sleeve 21 comes into contact with the outer circumferential surface of the shaft 11, a breakage can be prevented. The outer circumferential surface of an axially lower part of the sleeve 21 is opposed to the inner circumferential surface of the outer cylindrical portion 12c of the bush 12 with a small gap R1 interposed therebetween. An axially lower end face of the sleeve 21 is opposed to the axially upper face of the radially-extending portion 12b of the bush 12 with a gap interposed therebetween.

The rotor hub 22 includes a hub cylindrical portion 22a, a cover 22b, and a radially-extending portion 22c. The hub cylindrical portion 22a is hollow and has an inner circumferential surface secured to the outer circumferential surface of the sleeve 21 by bonding. The cover 22b is formed to cover an axially upper end of the hub cylindrical portion 22a. The radially-extending portion 22c is arranged at an axially lower end of the hub cylindrical portion 22a and extends radially outward from the hub cylindrical portion 22a.

An increased-thickness portion 22d is formed axially above the hub cylindrical portion 22a of the rotor hub 22. The increased-thickness portion 22d is arranged above an axially upper end face of the sleeve 21 and has a radial thickness larger than that of the hub cylindrical portion 22a. An inner circumferential surface of the increased-thickness portion 22d and the outer circumferential surface of the shaft 11 overlap each other in the radial direction, and are opposed to each other with a small radial gap interposed therebetween. The cover 22b is continued from the increased-thickness portion 22d and covers a hollow defined in the increased-thickness portion 22d. The cover 22b is axially opposed to the axially upper end face of the shaft 11 with an axial gap interposed therebetween. Due to the small radial gap between the inner circumferential surface of the increased-thickness portion 22d and the outer circumferential surface of the shaft 11, it is possible to prevent a foreign particle to enter the bearing 30 even if the foreign particle adheres to the cover 22b during processing of the rotor hub 22. Therefore, a reliable motor in which seizing of the bearing 30 caused by a foreign particle does not occur can be provided.

The yoke 23 is formed of magnetic material by plastic work such as pressing, and is secured to an outer circumference of the radially-extending portion 22c by plastic work such as crimping. The rotor magnet 24 is fixed at an axially center of an inner circumferential surface of the yoke 23. An inner circumferential surface of the rotor magnet 24 and the outer circumferential surface of the stator core 13a of the stator 13 are radially opposed to each other with a radial gap interposed therebetween.

### 3) Bearing 30

In the present invention, the bearing 30 uses gas as lubricating fluid. Air is used as the gas in this preferred embodiment. A plurality of radial dynamic pressure generating grooves are formed in the outer circumferential surface of the shaft 11, and generate points where an air pressure is increased by rotation of the rotary unit 20 including the sleeve 21. The rotary unit 20 is radially supported by the air pressure so as to be rotatable. In addition, the rotary unit 20 is axially supported by a static pressure in the axial gap between the upper face of the shaft 11 and the lower face of the cover 22b of the rotor hub 22. A bearing hole recited in the claims is formed by the inner circumferential surface of the sleeve 21 and the axially lower face of the cover 22b. The bearing hole is filled with gas as lubricating fluid, i.e., air.

The structure of an upper part of the bearing 30 is now described, referring to FIG. 2.

An axially lower face of the increased-thickness portion 22d of the rotor hub 22 is opposed to the axially upper end face of the sleeve 21 with a small gap H1 interposed therebetween. With this configuration, irrespective of precision of a right angle formed by the outer circumferential surface of the sleeve 21 and the axially upper face thereof, the outer circumferential surface of the sleeve 21 can be fixed to the inner circumferential surface of the hub cylindrical portion 22a of the rotor hub 22. Therefore, the inner circumferential surface of the sleeve 21 and the outer circumferential surface of the shaft 11 can be accurately arranged in parallel with each other along the axial direction. This arrangement is suitable for an air bearing in which the size of the radial gap between the outer circumferential surface of the shaft 11 and the inner circumferential surface of the sleeve 21 is several microns and a supporting force in the radial direction is weak.

Moreover, if adhesive interposed between the outer circumferential surface of the sleeve 21 and the inner circumferential surface of the hub cylindrical portion 22a reaches the axially upper face of the sleeve 21, the adhesive can be received in the small gap H1. Therefore, the sleeve 21 is not inclined due to the influence of the adhesive radially outward or inward. In addition, if the adhesive expands under high-temperature environment, the increased volume of the adhesive can be received in the small gap H1. Therefore, even under high-temperature environment, the sleeve 21 is not inclined radially outward or inward. Furthermore, the small gap H1 is formed to be adjacent to the bearing 30 in the radially outside of the bearing 30. Therefore, abrasion powders generated in the bearing 30 can be received in the small gap H1 by a centrifugal force. As a result, it is possible to provide a reliable bearing 30, in which the bearing precision is not changed by an environment change and seizing is prevented by releasing the abrasion powers to the outside of the bearing 30, and a reliable motor including such a bearing.

On an axially lower face of the increased-thickness portion 22d, a step 22d1 is formed in the radially outside of the small gap H1. Thus, a part of the axially lower face of the increased-thickness portion 22d, arranged radially outside the step 22d1, is axially lower than another part thereof arranged radially inside the step 22d1. With this arrangement, the radially outer part of the axially lower face of the increased-thickness portion 22d can regulate axial upward movement of the sleeve 21 by coming into contact with the sleeve 21 when the sleeve 21 moves upward in the axial direction due to contraction or expansion of adhesive at the time of bonding the sleeve 21 and the hub cylindrical portion 22a to each other. Therefore, axial positioning precision of the sleeve 21 can be improved.

A recess 22d2 which is concave radially outward is formed near a corner formed by the axially lower face of the increased-thickness portion 22d and the inner circumferential surface of the hub cylindrical portion 22a. The recess 22d2 is arranged to form a radial gap between the hub cylindrical portion 22a and the outer circumferential surface of the sleeve 21. Thus, even if adhesive for fixing the sleeve 21 and the rotor hub 22 to each other is too much, the excess adhesive can be received in the recess 22d2 before reaching the small gap H1.

### <Arrangement for Regulating Axial Movement of Rotary Unit 20>

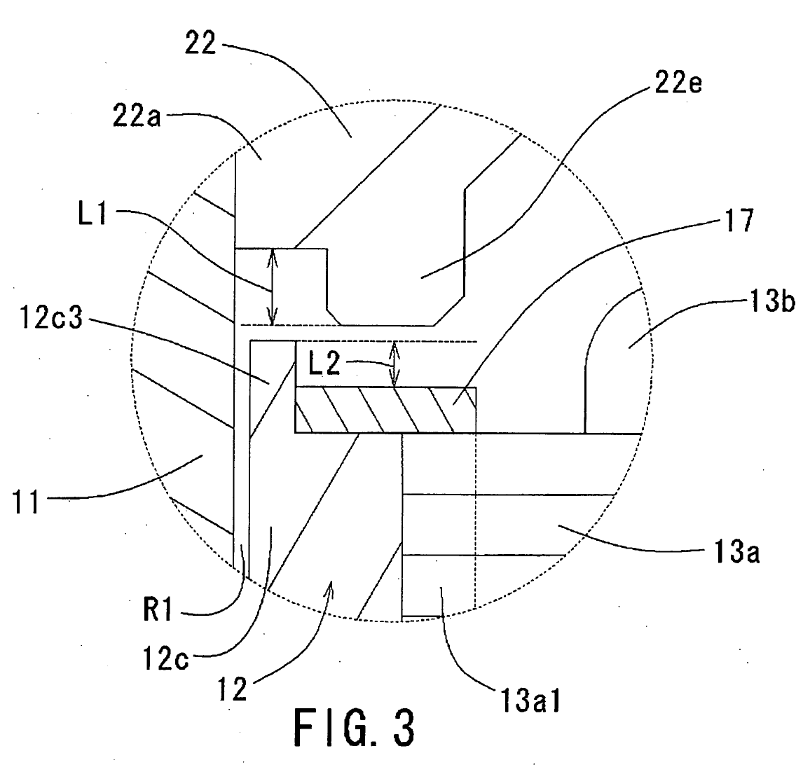

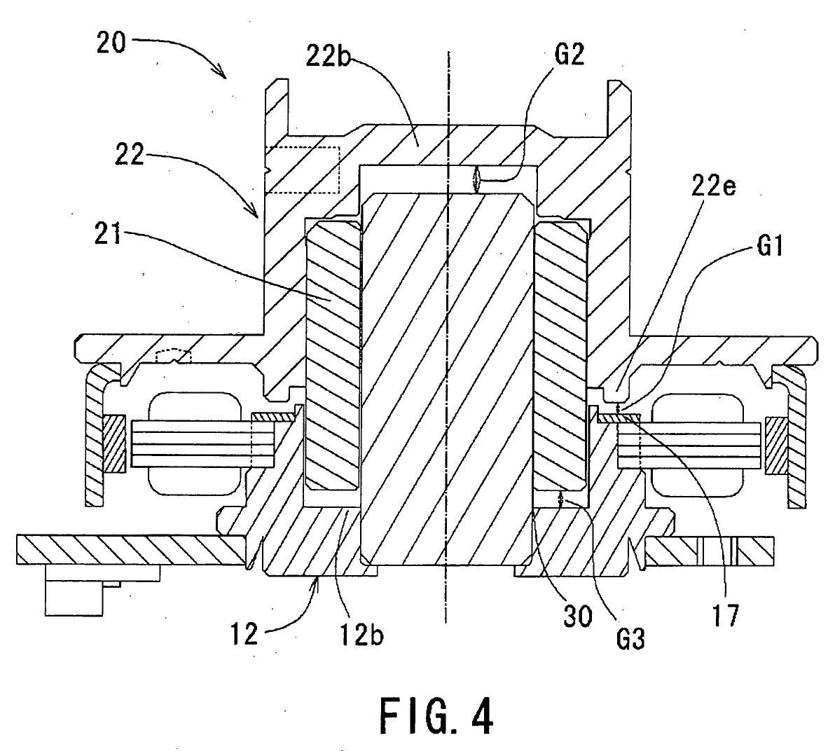

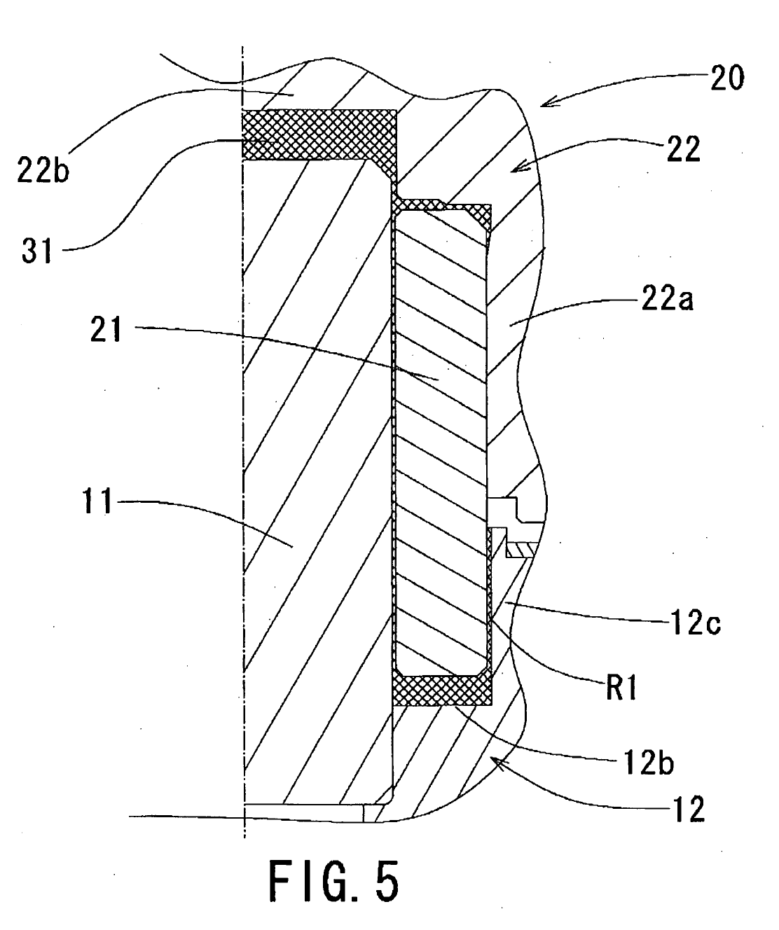

Next, an arrangement for regulating axial movement of the rotary unit 20 according to this preferred embodiment of the present invention is described referring to FIGS. 3 to 5. FIG. 3 is an enlarged view of a portion of the motor surrounded by a circle of dotted line in FIG. 1. FIG. 4 shows the axial gaps between the fixed unit 10 and the rotary unit 20 of the motor near the bearing 30. FIG. 5 is an enlarged view of a portion of the motor of FIG. 1 around the bearing 30.

First, an arrangement for regulating axially downward movement of the rotary unit 20 relative to the fixed unit 10 is described, referring to FIGS. 3 and 4.

Referring to FIG. 3, an annular wall 12c3 is formed on an inner periphery of the axially upper face of the outer cylindrical portion 12c of the bush 12. The level of a radially outer part of the axially upper face of the outer cylindrical portion 12c is approximately coincident with the level of the axially upper face of the core back portion 13a1 of the stator 13 in the axial direction. Please note that the radially outer part of the axially upper face of the outer cylindrical portion 12c includes an outer periphery thereof. In the radially outside of the annular wall 12c3, a sliding seal 17 as an annular sliding member formed of material having high slidability is secured on the axially upper face of the outer cylindrical portion 12c. An example of the material for the sliding seal 17 is fluorine resin having good slidability. An axially upper face of the sliding seal 17 forms the first contact portion recited in the claims.

The rotor hub 22 is provided with an annular projection 22e axially opposed to the sliding seal 17. The annular projection 22e is arranged radially outside the annular wall 12c3 and radially inside a radially inner side of the coil 13b. An axially lower face of the annular projection 22e forms the second contact portion recited in the claims. A length L1 between an axially lower end face of the hub cylindrical portion 22a and an axially lower end face of the annular projection 22e is larger than a length L2 between the axially upper face of the sliding seal 17 and the axially upper face of the annular wall 12c3, that is, L1>L2. With this configuration, even when the rotor hub 22 moves downward in the axial direction due to an external shock or the like, the axially lower end face of the annular projection 22e comes into contact with the axially upper face of the sliding seal 17 before the axially lower face of the hub cylindrical portion 22a comes into contact with the axially upper face of the annular wall 12c3. That is, the axially lower end face of the hub cylindrical portion 22a does not come into contact with the axially upper face of the annular wall 12c3.

It is preferable that both a radial width of the sliding seal 17 and a radial width of the axially lower end face of the annular projection 22e be as large as possible under an upper limit determined for design reasons. The radial width of the sliding seal 17 is defined as a radial length between inner and outer peripheries of the sliding seal 17. With the configuration, a contact pressure applied to the annular projection 22e and the sliding seal 17 can be reduced when the rotor hub 22 moves downward in the axial direction and comes into contact with the sliding seal 17. Therefore, breakage caused by the contact between the annular projection 22e and the sliding seal 17 can be prevented. The outer periphery of the sliding seal 17 may be located above the core back portion 13a1 of the stator 13. In this case, the radial width of the sliding seal 17 can be increased. Therefore, an area where the sliding seal 17 is in contact with the axially lower end face of the annular projection 22e can be increased.

The axially upper face of the annular wall 12c3 is formed axially above the axially upper face of the sliding seal 17. Thus, even if any of the annular projection 22e and the sliding seal 17 is broken due to contact between them, the annular wall 12c3 can prevent entering of a broken piece into the bearing 30. Therefore, a reliable motor in which seizing of the mechanism 30 does not occur can be provided.

Referring to FIG. 4, size relationships among an axial gap G1 between the axially upper face of the sliding seal 17 and the axially lower face of the annular projection 22e of the rotor hub 22, an axial gap G2 between the axially upper face of the shaft 11 and the axially lower face of the cover 22b of the rotor hub 22, and an axial gap G3 between the axially lower face of the sleeve 21 and the axially upper face of the radially-extending portion 12b of the bush 12 are described. In this preferred embodiment, it is essential that the size of the axial gap G1 is smaller than those of the axial gaps G2 and G3, that is, G1<G2 and G1<G3. With this configuration, even if the rotary unit 20 including the rotary hub 22 and the sleeve 21 moves downward in the axial direction, contact between the fixed unit 10 and the rotary unit 20 occurs only between the annular projection 22e and the sliding seal 17, i.e., in the radially outside of the bearing 30. That is, it is possible to prevent contact between the shaft 11 adjacent to the bearing 30 and the cover 22b of the rotor hub 22 and contact between the sleeve 21 and the bush 12. This means that contact in regions where a broken piece can easily enter the bearing me 30 can be prevented. Thus, seizing of the bearing 30 can be prevented and therefore a reliable motor can be provided.

Next, an arrangement for regulating axially upward movement of the rotary unit 20 relative to 10 is described, referring now to FIG. 5.

The rotor hub 22 is formed in a bag-like shape by the hub cylindrical portion 22a and the cover 22b. A small gap R1 is formed between the outer circumferential surface of an axially lower part of the sleeve 21 secured to the inner circumferential surface of the hub cylindrical portion 22a and the inner circumferential surface of the outer cylindrical portion 12c of the bush 12. Thus, a flow of air to the outside can be reduced near the bearing 30. With the configuration, a portion around the bearing 30 is approximately hermetically closed. A bearing space 31 near the bearing 30 contains the small gap R1 and a space surrounded by the axially lower face of the cover 22b of the rotor hub 22, the inner circumferential surface of the sleeve 21, the axially lower face of the sleeve 21, the axially upper face of the shaft 11, the outer circumferential surface of the shaft 11, and the axially upper face of the radially-extending portion 12b of the bush 12, as shown with hatching in FIG. 5. Moreover, the size of the axial gap G3 between the axially lower face of the sleeve 21 and the axially upper face of the radially-extending portion 12b of the bush 12 is larger than the size of a radial gap between the outer circumferential surface of the shaft 11 and the inner circumferential surface of the sleeve 21 and the size of the small gap R1 between the outer circumferential surface of the sleeve 21 and the inner circumferential surface of the outer-cylindrical portion 12c of the bush 12.

When the volume of the bearing space 31 increases with axially upward movement of the rotor hub 22 and sleeve 21, an air pressure in the bearing space 31 becomes lower than that of the outside air. This phenomenon occurs because the small gap R1 communicated with the outside air suppresses the flow of air from the outside. That is, the amount of air flowing into the bearing space 31 from the outside is suppressed although the volume of the bearing space 31 is increased. Therefore, the air pressure in the bearing space 31 becomes lower than that of the outside air. Thus, a force to balance the air pressure in the bearing space 31 with that of the outside air acts in the bearing space 31. As a result, a force for reducing the increased volume of the bearing space 31 acts. That is, a force of moving the rotor hub 22 and the sleeve 21 downward in the axial direction acts. In this manner, axially upward movement of the rotary unit 20 can be regulated.

For example, in a case where the small gap R1 is formed to be perpendicular to a direction of axial movement of the rotary unit 20, the width of the small gap R1 increases when the rotary unit 20 moves upward in the axial direction. As a result, the inflow amount of air from the outside into the bearing space 31 increases and, in a state where the rotary unit 20 moves upward in the axial direction, the air pressure in the bearing space 31 and the air pressure on the outside are balanced. Therefore, a force of moving the rotary unit 20 downward in the axial direction does not act, and there is no effect of regulating the axially upward movement of the rotary unit 20. However, in this preferred embodiment, the small gap R1 is formed to have the unchanged radial width so as to keep the effect of suppressing an incoming flow of air from the outside of the small gap R1 even when the rotary unit 20 moves axially upward. That is, the small gap R1 is formed to be approximately parallel to the direction of the axially upward movement of the rotary unit 20. Thus, the air pressure in the bearing space 31 becomes lower with the increase in the volume thereof. Therefore, the effect of regulating axially upward movement of the rotary unit 20 can be achieved. This is advantageous in that axially upward movement of the rotary unit 20 can be regulated without increasing the number of parts, resulting in reduction in price of the motor. In this preferred embodiment, R1 is set to 0.2 mm or less.

### <Another Preferred Embodiment>

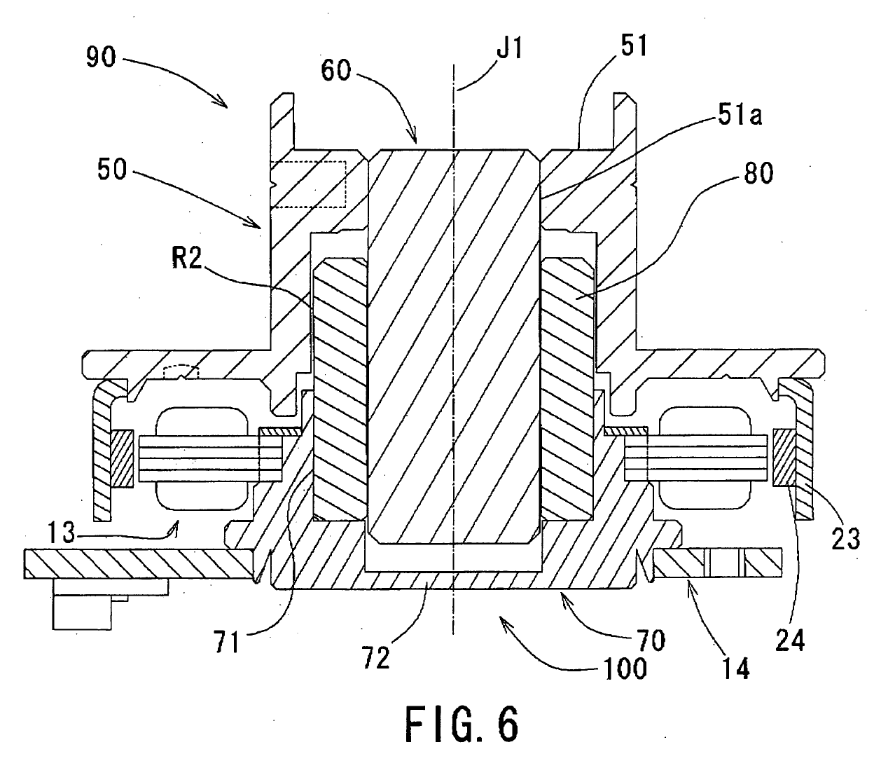

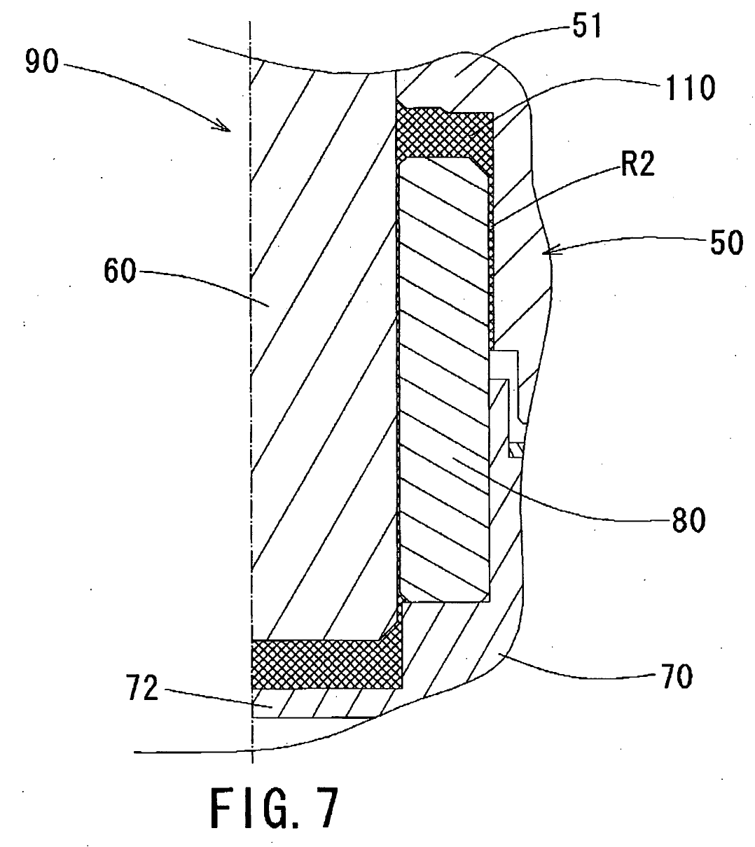

A brushless motor according to another preferred embodiment of the present invention is now described, referring to FIGS. 6 and 7. The differences between this preferred embodiment and the above preferred embodiment are mainly described below.

Referring to FIG. 6, a hole 51a is formed in a cover 51 of a rotor hub 50. A shaft 60 is secured in the hole 51a. A sleeve fixing recess 71 for fixing a sleeve 80 is formed in a bush 70. The shaft 60 is rotatably supported by the sleeve 80. In the bush 70, a bottom 72 is formed so as to be opposed to an axially lower face of the shaft 60 with an axial gap interposed therebetween.

A rotary unit 90 includes the rotor hub 50, the shaft 60, the yoke 23, and the rotor magnet 24. A fixed unit 100 includes the bush 70, the sleeve 80, the stator 13, and the mounting plate 14.

An outer circumferential surface of the sleeve 80 and the inner circumferential surface of a hub cylindrical portion 52 of the rotor hub 50 are radially opposed to each other with a small gap R2 interposed therebetween. The small gap R2 is communicated with the outside air.

Referring now to FIG. 7, a bearing space 110 contains the small gap R2 and a space surrounded by the bottom 72 of the bush 70, the inner circumferential surface of the sleeve 80, the axially upper face of the sleeve 80, the axially lower face of the cover 51 of the rotor hub 50, the outer circumferential surface of the shaft 60, and the axially lower face of the shaft 60, as shown with hatching in FIG. 7. A radial width of the gap R2 does not increase even when the rotary unit 90 moves upward in the axial direction. Therefore, the same effect as those obtained in the aforementioned embodiment can be achieved.

### <Method for Manufacturing Motor>

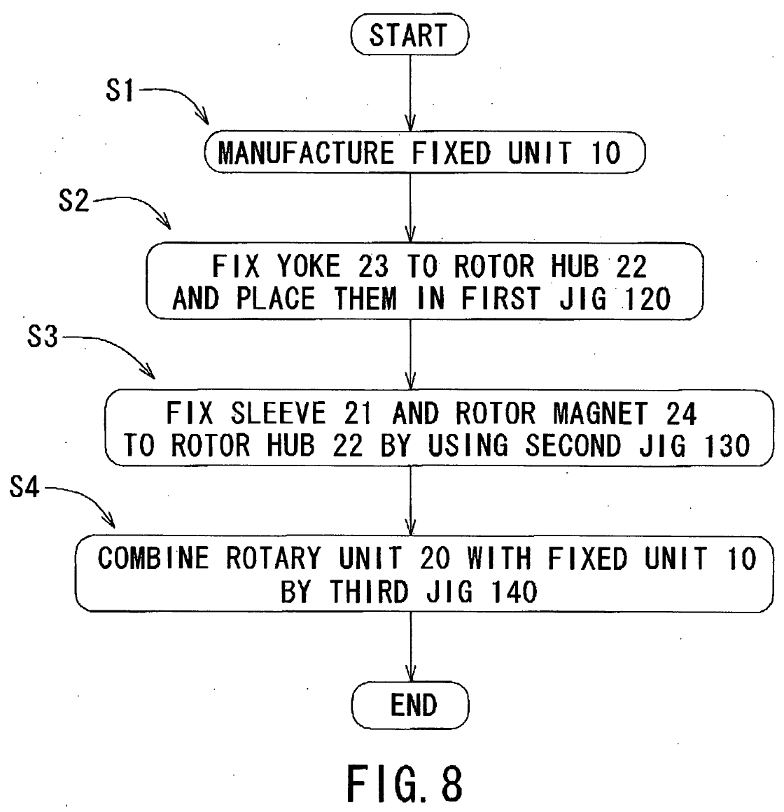

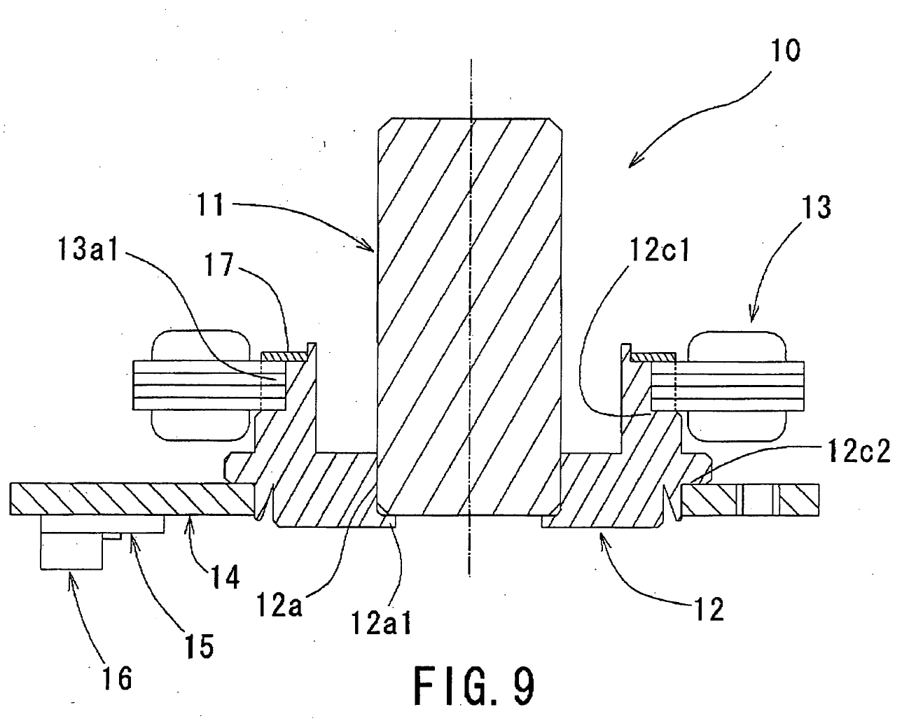

A method for manufacturing a motor according to a preferred embodiment of the present invention is now described, referring to FIGS. 8 to 12. FIG. 8 is a flowchart of the manufacturing method. FIGS. 9 to 12 are diagrams showing respective steps of the manufacturing method.

First, the fixed unit 10 is manufactured in Step S1 (see FIG. 9).

The shaft 11 is press-fitted into the shaft fixing portion 12a of the bush 12. The axially lower face of the shaft 11 comes into contact with the annular projection 12a1 of the bush 12, thereby positioning the shaft 11. Consequently, the shaft 11 can be fixed to the bush 12 with high precision in both the radial and axial directions. Moreover, adhesive is applied between the shaft 11 and the shaft fixing portion 12a. Therefore, fixing strength can be improved. To the lower step 12c2 in the outer circumferential surface of the bush 12, the mounting plate 14 on which the circuit board 15 and the connector 16 are mounted is secured by plastic work such as crimping. The stator 13 is secured to the upper step 12c1 of the bush 12 with adhesive. The level of the axially upper face of the bush 12 and the level of the axially upper face of the core back portion 13a1 of the stator 13 are approximately coincident with each other in the axial direction. The sliding seal 17 is secured above the axially upper surface of the bush 12 and the axially upper face of the core back portion 13a1.

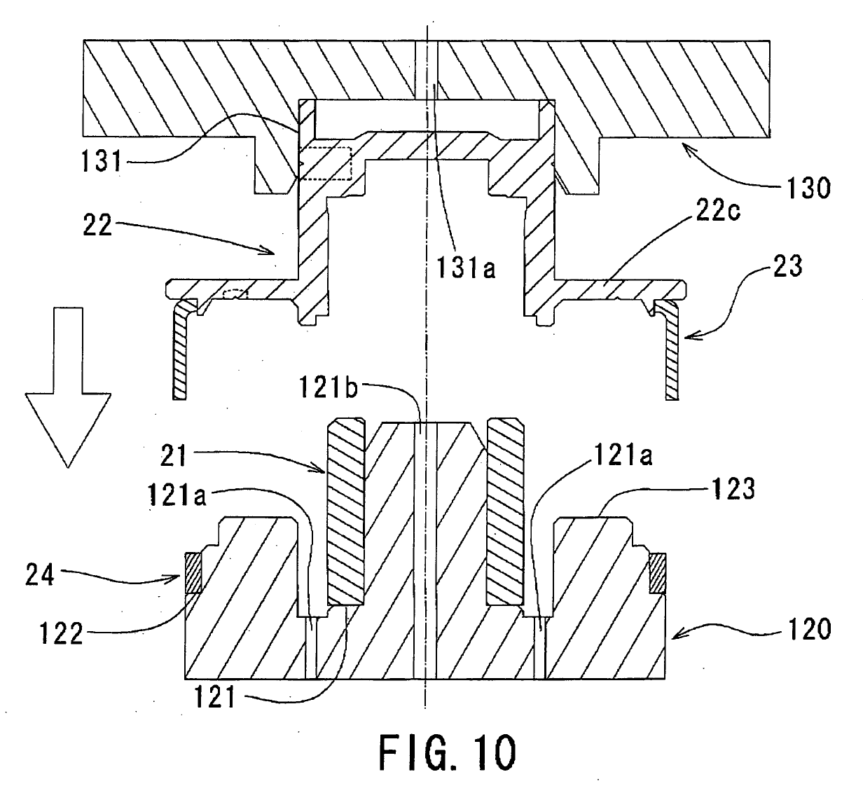

The rotor hub 22 and the yoke 23 are fixed to each other by plastic work such as crimping. The sleeve 21 having an annular shape and the rotor magnet 24 are fixed to a first jig 120 that can make centers of the sleeve 21 and the rotor magnet 24 coincident with each other with high precision in Step S2 (see FIG. 10).

The first jig 120 includes a sleeve positioning portion 121 and a magnet positioning portion 122 that can precisely determine a height of the axially lower face of the radially-extending portion 22c of the rotor hub 22 from the axially lower end face of the sleeve 21 and a height thereof from the axially lower end face of the rotor magnet 24, respectively. The first jig 120 also includes a positioning projection 123 arranged between the sleeve positioning portion 121 and the magnet positioning portion 122 in the radial direction. The positioning projection 123 axially positions the rotor hub 22 by coming into contact with the axially lower face of the radially-extending portion 22c of the rotor hub 22. That is, the axial height of an axially upper face of the positioning projection 123 of the first jig 120 from the axially upper face of the sleeve positioning portion 121 and the axial height of the axially upper face of the positioning projection 123 from the axially upper face of the magnet positioning portion 122 are coincident with the axial height of the axially lower face of the radially-extending portion 22c of the rotor hub 22 from the axially lower end face of the sleeve 21 and the axial height of the axially lower face of the radially-extending portion 22c from the axially lower end face of the rotor magnet 24, respectively. Positions in the radial direction of the sleeve 21 and the rotor magnet 24 can be also determined by the precision of the first jig 120. Therefore, the rotation center of the sleeve 21 and that of the rotor magnet 24 can be accurately made coincident with each other.

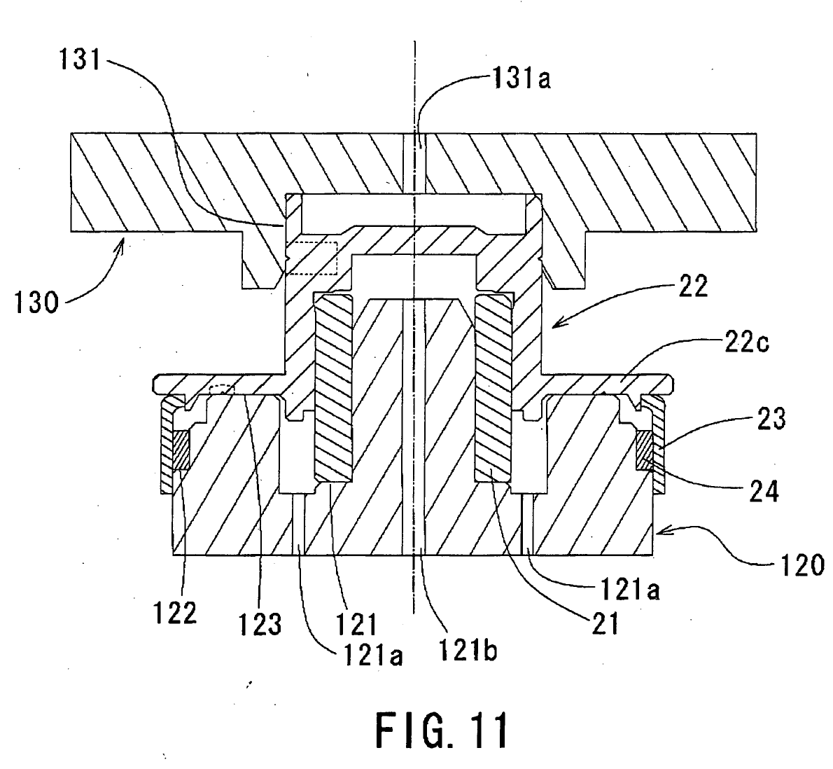

The rotor hub 22 with the yoke 23 fixed thereto is held by a second jig 130. The sleeve 21, and the rotor magnet 24 are fixed to the inner circumferential surface of the rotor hub 22 and the inner circumferential surface of the yoke 23 with adhesive, respectively, in Step S3 (see FIG. 11). In this manner, the rotary unit 20 can be manufactured.

The second jig 130 is arranged coaxially with the first jig 120, and has at its center a fixing portion 131 for fixing the rotor hub 22. Axially downward movement of the second jig 130 brings the axially lower face of the radially-extending portion 22c of the rotor hub 22 into contact with the axially upper face of the positioning projection 123 of the first jig 120. Thus, the sleeve 21 and the rotor magnet 24 can be axially positioned with respect to the rotor hub 22 with high precision. Accordingly, it is possible to precisely control the size of the gap G1 between the axially upper face of the sliding seal 17 and the axially lower face of the annular projection 22e and the size of the gap G3 between the axially upper face of the radially-extending portion 12b of the bush 12 and the axially lower end face of the sleeve 21.

In the radially outside of the sleeve positioning portion 121 of the first jig 120 is formed a first air vent port 121a communicated with the outside air. The first air vent port 121a is arranged adjacent to the sleeve positioning portion 121. A second air vent port 121b is similarly formed in the radially inside of the sleeve positioning portion 121.

When the rotor hub 22 is secured to the sleeve 21 in Step S3, a space surrounded by the outer circumferential surface of the sleeve 21, the positioning projection 123, and the radially-extending portion 22c of the rotor hub 22 is communicated with the outside air via the first air vent port 121a. Therefore, an air pressure in that space can be adjusted. The second air vent port 121b also has a similar effect.

A third air vent port 131a is formed at the center of the second jig 130. The third air vent port 131a allows a space surrounded by the cover 22b of the rotor hub 22 and the second jig 130 to be communicated with the outside air. Therefore, an air pressure in that space can be also adjusted.

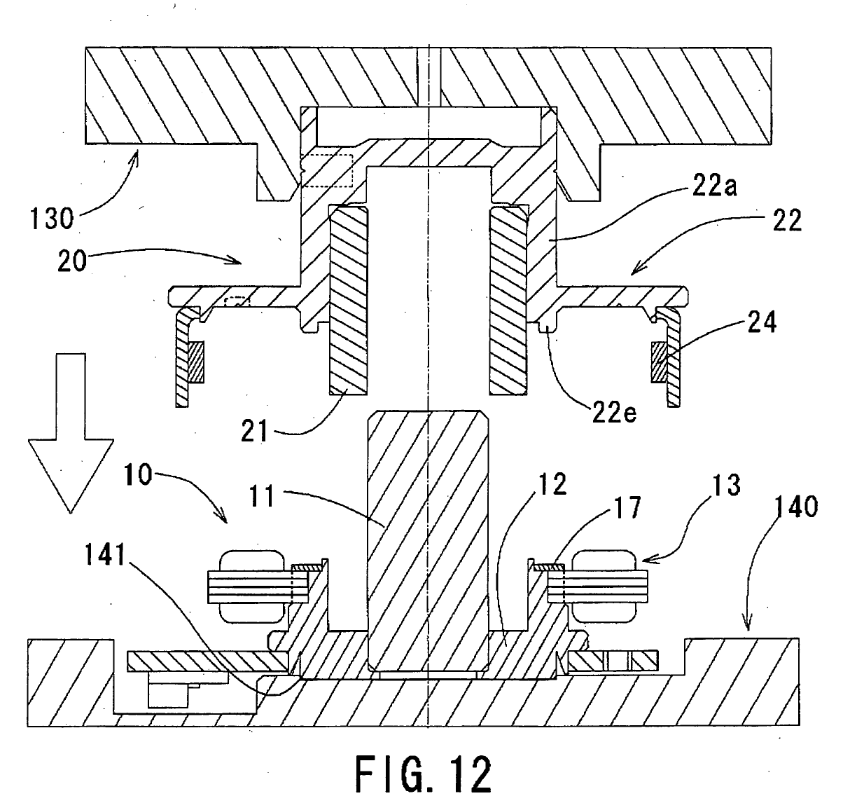

Then, the rotary unit 20 is combined with the fixed unit 10 in Step S4 (see FIG. 12). The fixed unit 10 is inserted into the rotary unit 20.

The second jig 130 holds the outer circumferential surface of the hub cylindrical portion 22a of the rotor hub 22, thereby holding the rotary unit 20. A third jig 140 holds the fixed unit 10. The third jig 140 includes a bush positioning portion 141 for fixing the outer circumferential surface of an axially lower part of the bush 12. The coaxiality of the second and third jigs 130 and 140 is precisely ensured by a connecting portion (not shown). Thus, the coaxiality of the fixed unit 10 and the rotary unit 20 can be ensured by jig precision of the second and third jigs 130 and 140. By inserting the shaft 11 into the sleeve 21, the fixed unit 10 and the rotary unit 20 are combined with each other. The shaft 11 is inserted until the axially lower face of the annular projection 22e of the rotor hub 22 comes into contact with the axially upper face of the sliding seal 17. Then, the second jig 130 is lifted up in the axial direction, so that the rotor hub 22 moves axially upward to a magnetic center of the rotor magnet 24 and the stator 13.

The preferred embodiments have been described above. However, the present invention is not limited thereto but can be modified in various ways within the scope of claims.

For example, the sliding seal 17 is secured on the axially upper face of the bush 12 in the above preferred embodiments. However, the present invention is not limited thereto. The axially upper face of the bush 12 or the axially upper face of the stator core 13a of the stator 13 may come into contact with the annular projection 22e of the rotor hub 22. Moreover, it is unnecessary to form the annular projection 22e in the rotor hub 22, as long as an axial gap between the rotor hub 22 and any one of the sliding seal 17, the bush 12, and the stator core 13 is smaller than the gap G2 between the end face of the shaft 11 and the cover 22b of the rotor hub 22 and the gap G3 between the axially lower face of the sleeve 21 and the axially upper face of the radially-extending portion 12b of the bush 12. Furthermore, the annular projection 22e of the rotor hub 22 may be divided into a plurality of projections in its circumferential direction. In this case, each of the divided projections has an arc shape centering around the rotation axis J1. Adjacent arc-shaped projections may be away from each other. Moreover, the effects of the present invention can be achieved by providing at least one arc-shaped projection.

In addition, the shape of the sliding seal 17 is not limited to the annular shape described in the above preferred embodiments. For example, the sliding seal 17 may have an arc shape. In a case where the annular projection 22e of the rotor hub 22 is circumferentially divided into a plurality of projections, it is desirable that a circumferential size of the arc-shaped sliding seal 17, i.e., a circumferential length between both circumferential ends of the sliding seal 17 be smaller than a circumferential size of each projection 22e.

Although the yoke 23 formed of magnetic material is secured on or near the outer periphery of the radially-extending portion 22c of the rotor hub 22 in the above preferred embodiments, the present invention is not limited thereto. However, it is necessary to arrange a magnetic member at a position where the rotor magnet 24 is to be secured in order to increase magnetic efficiency of the rotor magnet 24. Therefore, the rotor hub 22 itself may be formed of magnetic material, for example. In this case, the rotor hub 22 may be formed to include a magnetic holding portion extending axially downward from a portion on or near the outer periphery of the radially-extending portion 22c, in place of the yoke 23.

Although the axially lower end face of the shaft 11 is axially positioned by coming into contact with the annular projection 12a1 of the bush 12 in the above preferred embodiments, the present invention is not limited thereto. For example, a jig (not shown) for fixing the shaft 11 and the bush 12 to each other may be provided with a positioning projection used for axially positioning the shaft 11, so that the shaft 11 is axially positioned with respect to the bush 12.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A motor comprising a fixed unit, a rotary unit, and a bearing supporting the rotary unit in a rotatable manner relative to the fixed unit, wherein
one of the fixed unit and the rotary unit has an approximately cylindrical bearing hole closed at one of its axial ends, and the other includes a shaft received in the bearing hole in a rotatable manner,
the bearing contains gas as lubricating fluid in the bearing hole and includes a radial dynamic pressure generating mechanism which, by rotating in a predetermined direction, generates a radial supporting force and increases a static pressure of the gas between an axial end of the shaft axially opposed to the closed end of the bearing hole and the closed end of the bearing hole,
the fixed unit includes a first contact portion arranged radially outside the radial dynamic pressure generating mechanism, and the rotary unit includes a second contact portion axially opposed to the first contact portion, and
a size of an axial gap between the first and second contact portions is smaller than a size of an axial gap between the closed end of the bearing hole and the axial end of the shaft.

2. The motor according to claim 1, wherein
the rotary unit includes a rotor hub for supporting a rotatable object, and the fixed unit includes a stator for generating a rotating magnetic field and a bush for holding the stator, and
the first contact portion is an axially upper face of one of the bush and the stator and the second contact portion is an axially lower face of the rotor hub.

3. The motor according to claim 1, wherein
the rotary unit includes a rotor hub rotating around the rotation axis, and the fixed unit includes a stator for generating a rotating magnetic field, a bush for holding the stator, and a sliding member arranged on an axially upper face of the bush, and
the first contact portion is an axially upper face of the sliding member and the second contact portion is an axially lower face of the rotor hub.

4. The motor according to claim 3, wherein the sliding member is annularly arranged around the rotation axis.

5. The motor according to claim 3, wherein the sliding member is formed of fluorine resin.

6. The motor according to claim 3, wherein
the sliding member is approximately annular or arc-shaped, and
the bush is provided with an annular cylindrical wall arranged radially inside the sliding member, the annular cylindrical wall extending toward the rotor hub.

7. The motor according to claim 3, wherein
the stator includes a stator core and a coil formed by winding a wire around the stator core, the stator core having a plurality of magnetic steel sheets axially stacked and being secured to the bush, and
the sliding member covers at least a part of the axially upper face of the bush and at least a part of an axially upper face of the stator core.

8. The motor according to claim 1, wherein an axially extending gap is formed between a surface of the fixed unit and a surface of the rotating unit that are radially opposed to each other, is arranged radially outside the radial dynamic pressure mechanism to surround the radial dynamic pressure mechanism, and is connected to a gap formed between an outer circumferential surface of the shaft and a surface defining the bearing hole opposed to the outer circumferential surface of the shaft, and
the axially extending gap is in communication with outside air at one of its axial ends.

9. The motor according to claim 8, wherein another axial gap is formed between the axially extending gap and the gap between the outer circumferential surface of the shaft and the surface defining the bearing hole, and has an axial size larger than a size of the axially extending gap and a size of the gap between the outer circumferential surface of the shaft and the surface defining the bearing hole.

10. The motor according to claim 8, wherein the axially extending gap has an axial size larger than a size of the axial gap between the first and second contact portions.

11. The motor according to claim 1, wherein
the rotary unit includes: a rotor hub rotating around the rotation axis and having a cover opposed to the axial end of the shaft and a hub cylindrical portion; and a hollow, approximately cylindrical sleeve secured to an inner circumferential surface of the hub cylindrical portion and having an inner circumferential surface that forms together with an outer circumferential surface of the shaft the radial dynamic pressure generating mechanism, and
the cover of the rotor hub is axially opposed to an axially upper face of the sleeve with an axial gap interposed therebetween.

12. The motor according to claim 11, wherein the rotor hub is provided with an increased-thickness portion between the cover and the hub cylindrical portion, the increased-thickness portion being radially opposed to the outer circumferential surface of the shaft with a radial gap interposed therebetween.

13. The motor according to claim 11, wherein the rotary hub is provided with an increased-thickness portion between the cover and the hub cylindrical portion, the increased-thickness portion being radially opposed to the outer circumferential surface of the shaft with a radial gap interposed therebetween, and
an axially lower face of the increased-thickness portion is opposed to the axially upper face of the sleeve with an axial gap interposed therebetween.

14. The motor according to claim 13, wherein a step is formed in the axially lower face of the increased-thickness portion in such a manner that a part of the axially lower face of the increased-thickness portion radially outside the step is closer to the axially upper face of the sleeve than another part of the axially lower face of the increased-thickness portion radially inside the step.

15. The motor according to claim 11, wherein the rotor hub is provided with a recess that is concave radially outward, thereby forming a radial gap between an outer circumferential surface of the sleeve and the rotor hub.

16. The motor according to claim 13, wherein the rotor hub is provided with a recess that is concave radially outward, thereby forming a radial gap between an outer circumferential surface of the sleeve and the rotor hub.

17. A motor comprising a fixed unit, a rotary unit, and a bearing supporting the rotary unit in a rotatable manner relative to the fixed unit, wherein
one of the fixed unit and the rotary unit has an approximately cylindrical bearing hole closed at one of its axial ends, and the other includes a shaft received in the bearing hole in a rotatable manner around a rotation axis,
the bearing contains gas as lubricating fluid in the bearing hole, and includes a radial dynamic pressure generating mechanism which, by rotating in a predetermined direction, obtains a radial supporting force and increases a static pressure of the gas between an axial end of the shaft opposed to the closed end of the bearing hole and the closed end of the bearing hole,
an axially extending gap is formed between a surface of the fixed unit and a surface of the rotary unit that are radially opposed to each other, and is arranged radially outside the radial dynamic pressure generating mechanism to surround the radial dynamic pressure generating mechanism, and
the axially extending gap is connected to a gap between an outer surface of the shaft and a surface defining the bearing hole and is in communication with outside air at one of its axial ends.

18. The motor according to claim 17, wherein
one of the fixed unit and the rotary unit includes a hollow, approximately cylindrical sleeve having an inner circumferential surface opposed to the outer circumferential surface of the shaft, the sleeve forming the radial dynamic pressure generating mechanism, and
the axially extending gap contains an outer circumferential surface of the sleeve.

19. A manufacturing method of a motor including a fixed unit and a rotary unit, the fixed unit including: a shaft serving as a rotation axis and having an outer circumferential surface as a bearing face; a bush holding the shaft; and a stator secured to the bush, the rotary unit including: a sleeve having an inner circumferential surface as another bearing face that is radially opposed to the outer circumferential surface of the shaft; a rotor magnet rotating around the rotation axis and opposed to the stator; and a rotor hub holding the sleeve and directly or indirectly holding the rotor magnet, the rotor hub including an inner circumferential surface for holding an outer circumferential surface of the sleeve and a hollow, approximately cylindrical rotor magnet holding portion for holding the rotor magnet, the manufacturing method comprising:
holding the sleeve and the rotor magnet by a first jig that includes a sleeve positioning portion arranged coaxially with the rotation axis and radially and axially positioning the sleeve and a magnet positioning portion arranged coaxially with the sleeve positioning portion and radially and axially positioning the rotor magnet;
applying adhesive on the inner circumferential surface of the rotor hub and the rotor magnet holding portion;
holding the rotor hub by a second jig arranged axially above the first jig, the second jig arranging the rotor hub coaxially with the rotation axis; and
moving the second jig axially downward to bring the inner circumferential surface of the rotor hub into contact with the outer circumferential surface of the sleeve and bring the rotor magnet holding portion into contact with the rotor magnet.

20. The manufacturing method according to claim 19, wherein
the rotor hub is provided with a radially-extending portion axially opposed to the stator and extending radially outward from the inner circumferential surface of the rotor hub,
the first jig is provided with a positioning projection to come into contact with an axially lower face of the radially-extending portion, and
the second jig moves to bring the radially-extending portion of the rotor hub into contact with the positioning projection of the first jig, thereby determining positions of the sleeve and the rotor magnet relative to the rotor hub.
